(19) United States
(12) Patent Application Publication
(10) Pub. No.: US 2003/0180601 A1
(43) Pub. Date: Sep. 25, 2003

(54) Air-breathing fuel cell stack

(76) Inventors: Yukio Naruse, Inuyama-Shi (JP); Noboru Ohwaki, Inuyama-Shi (JP); Shoji Nawa, Inuyama-Shi (JP); Yasuo Ido, Inuyama-Shi (JP)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/369,086

(22) Filed: Feb. 18, 2003

(30) Foreign Application Priority Data
Mar. 22, 2002 (JP) 2002-080496

(51) Int. Cl. H01M 8/24; H01M 8/10; H01M 8/02

(52) U.S. Cl. 429/38; 429/32; 429/39; 429/30; 429/34

(57) ABSTRACT

There is provided an air-breathing fuel cell stack in which a sufficient amount of oxygen is supplied to an oxygen flow field plate so as to enhance an electric power-generating ability, and besides material costs can be reduced. An air-breathing fuel cell stack includes a pair of end plates, a plurality of unit cells, which are provided between the two end plates, a fuel distribution manifold provided in central portions of the unit cells so as to supply fuel thereto, a single tie bolt passing through a central portion of the fuel distribution manifold and the central portions of the unit cells so as to clamp the fuel cell components together into a unitary construction, and a pair of fixing bolts threaded respectively on both end portions of the tie bolt through O-rings, washers or the like to clamp the plurality of unit cells between the two end plates. The unit cell includes a polymer electrolyte membrane, an oxygen electrode and a fuel electrode disposed respectively on both sides of the polymer electrolyte membrane in opposed relation to each other, a flow field plate disposed adjacent to the oxygen electrode, and a pair of current collector plates contacting outer sides of the flow passage and fuel electrode, respectively. The end plate, the end gasket and the current collector plate have a communication passage which is open outwardly, and communicates with the oxygen flow field plate of the cell portion.

### CROSS-REFERENCE TO RELATED APPLICATIONS

This application claims priority based on Japanese Application No. 2002-080496, filed Mar. 22, 2002.

### BACKGROUND OF THE INVENTION

This invention relates to an air-breathing fuel cell stack as a solid polymer fuel cell stack which can be used as a power source or an electric generator for various applications such as outdoor, recreation and household applications and also for a business machine and the like, and is formed into a thin type, and is quiet, lightweight and pollution-free.

Generally, fuel cell stacks use hydrogen as main fuel and take out the energy generated during the chemical reaction of this hydrogen with oxygen. There are several types of fuel cell stacks, and one type of them is a solid polymer electrolyte fuel cell stack. This solid polymer electrolyte cell stack has features such as low operating temperature and high output density.

An example of such conventional solid polymer electrolyte fuel cell stack is disclosed in U.S. Pat. No. 5,595,834 or JP-A-2002-270212 which is a patent application filed earlier by the Applicant of the present application. In such a fuel cell stack shown in FIG. 7, an anode (fuel electrode) 13a and a cathode (oxygen electrode) 13b are provided on both sides of a polymer electrolyte membrane 12, and a fuel flow field plate and an oxygen flow field plate 18, which are provided on both sides of these fuel and oxygen electrodes 13a and 13b, and separator plates 34, which is provided respectively on both sides of these flow field plates 14 and 18, to form the unit cell 10 by making them integral with each other. A plurality of unit cells 10 are stacked together. Such separator plates, having terminals for outputting generated power, serve as current collector plates 35a and 35b. A fuel distribution manifold, forming of a hydrophilic sleeve 32, is provided to pass through a central hole in each unit cell 10, and is in communication with the fuel electrode 13a of each unit cell, and end plates 24 are provided respectively at both end portions of a tie bolt 26, passing through the center or axis of the sleeve 32, to sandwich them between the two ends of the bolt 26, and these fuel cell components are fastened and fixed together into a unitary construction by nuts 40 and 50 via washers and O-rings 36. Such fuel cell stacks are suitable for low power fuel cell stacks, and therefore can be designed as small-sized and lightweight fuel cell stacks.

In this polymer electrolyte fuel cell stack, fuel is supplied to the fuel electrode 13a through a central portion of the nut 40, and is distributed via the hydrophilic sleeve forming the fuel distribution manifold 32.

In the above conventional solid polymer electrolyte fuel cell, oxygen is introduced only from the outer periphery of the oxygen flow field plate 18, and therefore the oxygen has failed to sufficiently reach the central portion because of a flow resistance, so that the electric power-generating ability has been limited.

### SUMMARY OF THE INVENTION

The present invention was made in view of the above problem. Accordingly it is an object of this invention to provide air-breathing fuel cell stacks in which the area of contact between a cell portion and the air is so increased that a larger amount of oxygen can be introduced so as to enhance the electric power-generating ability.

Another object of the invention is to provide an air-breathing fuel cell stack in which an electric power-generating ability per unit volume is enhanced, thereby reducing material costs.

According to a first aspect of the invention for achieving the above objects, there is provided an air-breathing fuel cell stack in which an end plate, an end gasket and a current collector plate have a communication passage which is open outwardly, and communicates with a flow field plate of a cell portion.

The following functions are achieved by this first aspect of the invention.

(1) In a flow field plate of a conventional fuel cell stack , provided adjacent to an oxygen electrode, the air is introduced only from an outer periphery thereof, thereby supplying oxygen to the oxygen electrode. In this invention, however, the air can be supplied to the flow field plate also via the communication passage formed in the end plate, end gasket and current collector plate, so that the area of contact between the air and the flow field plate can be increased, and therefore a larger amount of oxygen can be supplied to the oxygen electrode, and the reaction between the oxygen and fuel (hydrogen) through a polymer electrolyte membrane is promoted, thereby enhancing the electric power-generating ability.

(2) Merely by providing the outwardly-open communication passage in the end plate, end gasket and current collector plate, the power generating ability per unit volume can be increased without adding any special part to these components, and therefore the material costs can be reduced.

This invention has a second aspect that the communication passage, formed in the end plate, end gasket and current collector plate, is defined by a plurality of through holes whose axes are substantially parallel to the axis of the cell portion.

(3) In this second aspect of the invention, the axes of the communication passage holes are parallel to the axis of the cell portion, and therefore the outside air can be supplied to the oxygen flow field plate via the shortest path, and a flow resistance is minimized, and oxygen can be supplied to the oxygen electrode uniformly over an entire area thereof, so that the power generating efficiency can be enhanced.

This invention has a third aspect that the cell portion comprises a pair of symmetrical unit cells, and the end plate and end gasket (provided at each of the opposite ends of said cell portion) and each current collector plate of each unit cell have the communication passage in communication with the corresponding flow passage plate.

The following functions are achieved by this third aspect of the invention.

(4) The cell portion has the two unit cells disposed on both sides of the central end gasket, respectively, and in each unit cell, the current collector plate, a fuel electrode, a polymer electrolyte membrane, the oxygen electrode, the oxygen flow passage plate and the current collector plate are arranged in this order from this central end gasket, and the end plates are provided respectively at the both ends of the cell portion, with the end gasket interposed between each unit cell and the corresponding end plate. Therefore, thanks to the provision of the flow passage leading from each end plate to the corresponding oxygen flow field plate, the air can be supplied to the oxygen flow field plates of the two unit cells respectively from the two end plates, and therefore a sufficient amount of oxygen can be supplied to the two unit cells, and not only the power generating ability but also the power generating capacity can be enhanced.

This invention has a fourth aspect that the communication passage, formed in the end plate, is defined by grooves which are formed in that side of the end plate, facing the cell portion, and are open outwardly perpendicularly to the axis of the cell portion.

(5) In this fourth aspect of the invention, the communication passage, formed in the end plate, is defined by a plurality of grooves which are formed in that side of the end plate, facing the cell portion, in opposed relation to the oxygen flow field plate, and are open radially outwardly, and therefore by forming through holes through the current collector plate, the outside air can be introduced from the outer periphery of the oxygen flow field plate, and can be supplied to the oxygen flow field plate uniformly over a wide area thereof, so that the power generating efficiency can be enhanced.

(6) In this fourth aspect, when a plurality of unit cells having the same arrangement of the components are stacked together, with the above end plate interposed between the adjacent unit cells, the outside air can be supplied to the oxygen flow field plate from its outer periphery, and also the air can be directly supplied via the grooves to the oxygen flow field plate radially outwardly over a wide area thereof, and therefore the power generating ability is higher than that of the conventional construction.

### BRIEF DESCRIPTION OF THE DRAWINGS

FIG. 1 is a schematic cross-sectional view of an air-breathing fuel cell stacks according to one preferred embodiment of the present invention.

FIGS. 2A and 2B show an end plate of the air-breathing fuel cell stack of FIG. 1, and FIG. 2A is a cross-sectional view taken along the line 2a-2a of FIG. 2B, and FIG. 2B is a front-elevational view thereof.

FIG. 3 is a schematic cross-sectional view of another embodiment of an air-breathing fuel cell stack of the invention.

FIG. 4 is a schematic cross-sectional view of a further embodiment of an air-breathing fuel cell stack of the invention.

FIGS. 5A and 5B show an end plate of the air-breathing fuel cell stack of FIG. 4, and FIG. 5A is a cross-sectional view taken along the line 5a-5a of FIG. 5B, and FIG. 5B is a front-elevational view thereof.

FIG. 6 is a graph showing output characteristics of air-breathing fuel cells stack of the invention.

FIG. 7 is a longitudinal cross-sectional view of a conventional polymer electrolyte fuel cell stack in a disassembled condition.

### DETAILED DESCRIPTION OF THE INVENTION

A preferred embodiment of the present invention will now be described in detail with reference to the drawings.

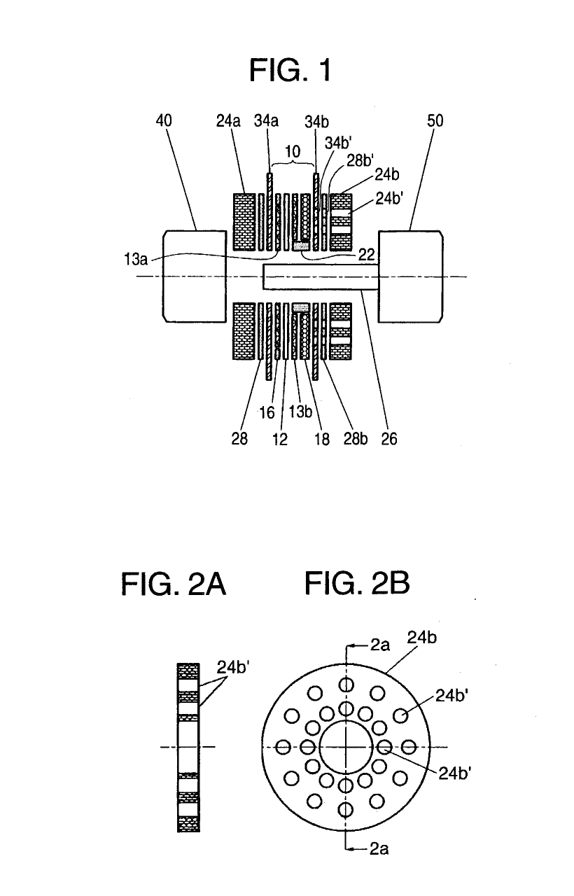

FIG. 1 is a cross-sectional view of one preferred embodiment of an air-breathing fuel cell stack of the invention in a disassembled condition, and FIGS. 2A and 2B show an end plate used in this air-breathing fuel cell stack, and FIG. 2A is a cross-sectional view taken along the line 2a-2a of FIG. 2B, and FIG. 2B is a plane view thereof. This air-breathing fuel cell stack is called a solid polymer fuel cell stack using fuel such as hydrogen. This fuel cell stack includes a unit cell 10 which comprises a solid polymer electrolyte membrane 12, which is made of a perfluorocarbon sulfonic acid polymer material, and has a thickness of 0.05 mm, a fuel electrode 13a which is made of a sheet-like carbon material, and has a thickness of 0.5 mm, an inner diameter of 15 mm and an outer diameter of 45 mm and an oxygen electrode 13b which is made of a sheet-like carbon material, and has a thickness of 0.5 mm, an inner diameter of 19 mm and an outer diameter of 55 mm, provided respectively on both sides of the polymer electrolyte membrane 12, an oxygen flow field plate 18 which is made of a carbon material, and has a thickness of 3.5 mm, an inner diameter of 19 mm and an outer diameter of 55 mm, provided on an outer side of the oxygen electrode 13b, an outer seal 16 of an annular shape which is made of synthetic rubber such as EPDM, and has a width of 5 mm, sealing an outer periphery of the fuel electrode 13a, an inner seal 22 which is made of synthetic rubber such as EPDM, and has a width of 2 mm, sealing inner peripheries of the oxygen electrode 13b and oxygen flow field plate 18, and current collector plates 34a and 34b each of which is made of stainless steel, and has a thickness of 0.3 mm and a diameter larger than those of the other components between which the above components are interposed. In the embodiments of the invention described below, fuel is mainly hydrogen, and oxygen is oxygen in the air, and is fed as the air. The solid polymer electrolyte membrane 12 is provided with a catalyst for chemical reaction.

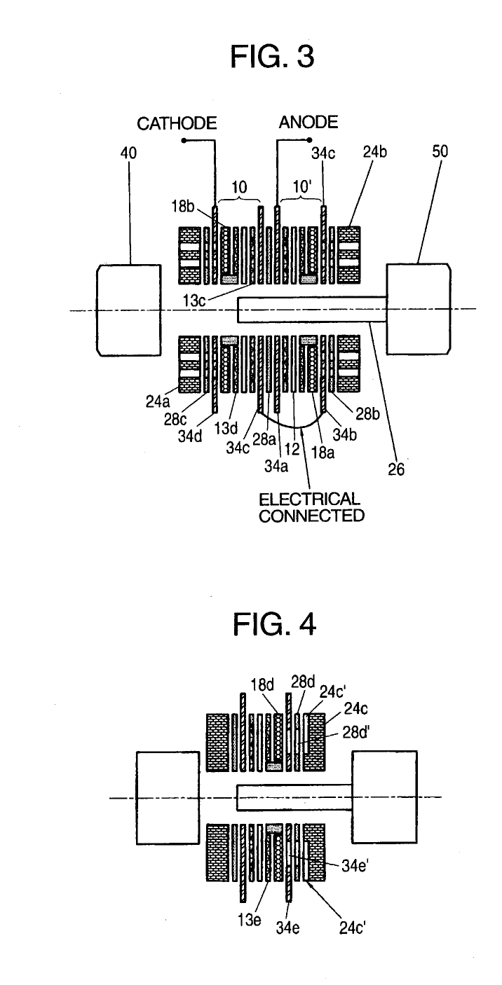

In another embodiment of an air-breathing fuel cell stack of the invention shown in FIG. 3, with respect to one unit cell 10, the order of stacking of components of the other unit cell 10′ is reversed, and more specifically a current collector plate, a fuel electrode, a polymer electrolyte membrane, an oxygen electrode, an oxygen flow field plate and a current collector plate of the other unit cell 10′ are stacked in this order from an end gasket 28a of the one unit cell 10, and these components are held by an end plate 24b through an end gasket 28b to form the other unit cell 10′, and the fuel cell components are clamped together into a unitary construction by threading nuts 40 and 50 respectively on both end portions of a tie bolt 26 as in the above embodiment.

By thus combining the two unit cells 10 and 10′ together, the outside air can be supplied to the oxygen electrode 13d as for the oxygen electrode 13b of the one unit cell 10 through communication holes in an end plate 24a, through holes in the end gasket 28c and current collector plate 34d and the oxygen flow field plate 18b. Since the two equivalent unit cells 10 and 10′ can be combined together, the power generating performance can be enhanced by supplying a sufficient amount of oxygen, and also the power generating capacity can be increased.

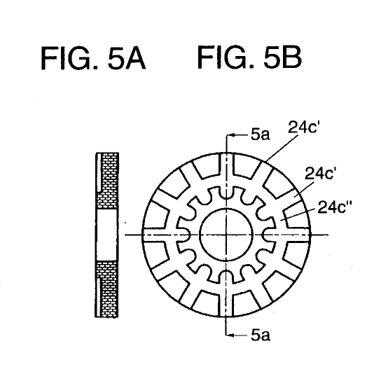

In a further embodiment of the invention shown in FIGS. 4, 5A and 5B, a plurality of grooves 24c′ are formed in that side (face) of an end plate 24c (disposed close to an oxygen electrode 13e) directed toward the oxygen electrode 13e, and extend perpendicularly to an axis of a unit cell, and further a circular groove 24c″, interconnecting these grooves 24c′, is formed in this side (face) of the end plate 24c as shown in FIG. 5B. Through holes 28d′, corresponding to the grooves 24c′ in the end plate 24c, are formed in an end gasket 28d, and also through holes 34e′, corresponding to the grooves 24′ in the end plate 24c, are formed in a current collector plate 34e. With this construction, the outside air is fed to an oxygen flow passage plate 18d via the radial grooves 24c′ and the through holes 28d′ and 34e′. Therefore, in this embodiment, also, a sufficient amount of oxygen can be supplied to the oxygen electrode 13e.

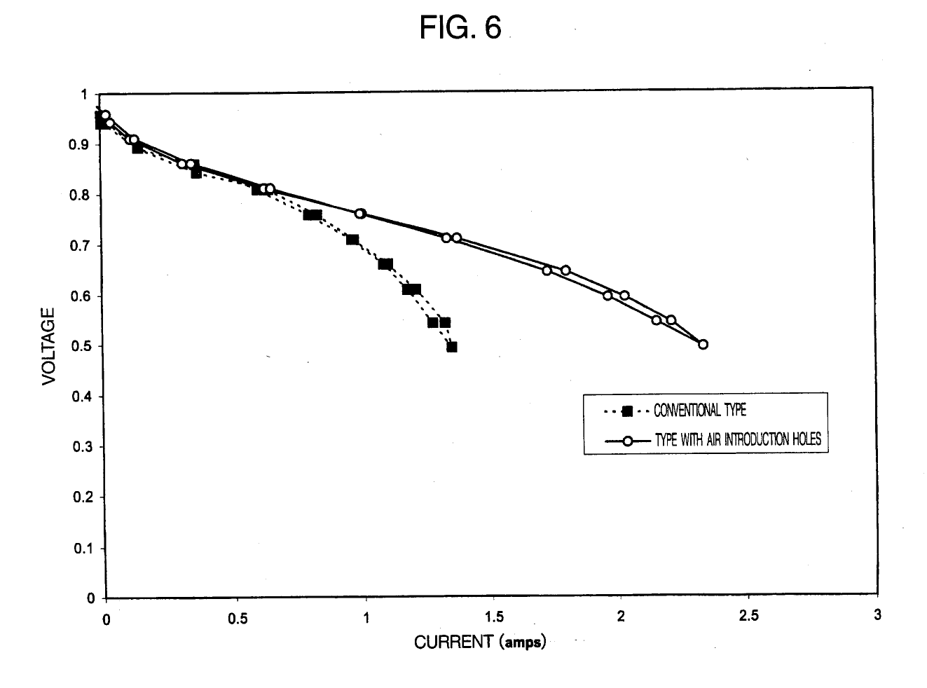

In comparison with the conventional fuel cell stack, the air-breathing fuel cell stacks of the above embodiments have the electric power-generating performance as shown in FIG. 6, and although there is no large difference between the two in a high-voltage, low-current output condition, a high-current output, not achieved with the conventional cells, can be obtained as the voltage drops, and the fuel cells of the invention can be suitably used for the wide range of applications.

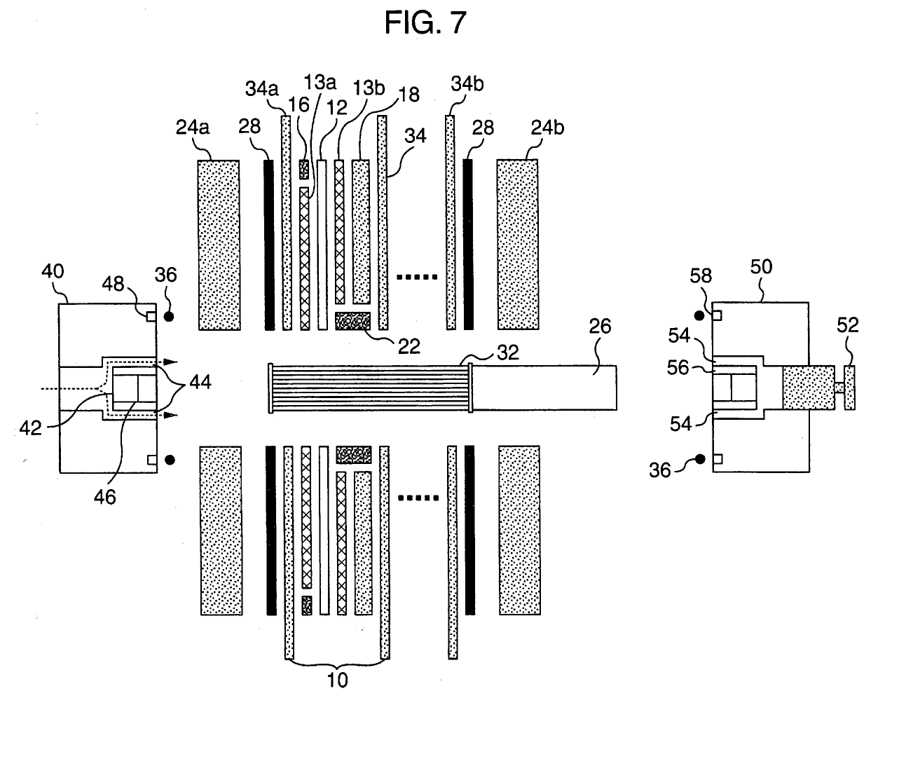

A desired number of unit cells 10 of the invention can be stacked together in accordance with a required output (See FIG. 7 which is a cross-sectional view of the conventional polymer electrolyte fuel cell), and the tie bolt 26, having a diameter of 6 mm and a length of 100 mm, is used to clamp the unit cells together into a unitary construction, and more specifically the fuel distribution manifold 32, formed of hydrophilic synthetic fiber yarns made of aromatic polyamide (KEVLAR) (tradename), is fitted on this tie bolt 26, and extends along the axis thereof, and this tie bolt 26 extends through the unit cells 10. The end gasket 28, made of synthetic rubber such as EPDM, is sandwiched between the current collector plate 34, serving as a separator plate of each of the opposite outermost unit cells 10, and the end plate 24a, 24b, and the stainless steel nuts 40 and 50 are threaded respectively on threaded portions, formed respectively at the opposite end portions of the tie bolt 26, in facing relation respectively to the end plates 24a and 24b each made of an epoxy resin and having a thickness of 10 mm, an inner diameter of 15 mm and an outer diameter of 55 mm, and by doing so, the components of the unit cell 10 can be clamped together into a unitary construction, and also a plurality of unit cells 10 can be clamped together into a unitary construction.

In FIG. 1, communication holes 24b′ are formed through the end plate 24b, disposed close to the oxygen flow field plate 18, and are aligned with through holes 28b′, formed through the end gasket 28b, and through holes 34b′ formed through the current collector plate 34b. These communication holes 24b′ are arranged as shown in FIGS. 2A and 2B, and communicate with the oxygen flow field plate 18. The air can be introduced into the oxygen flow field plate 18 from its outer periphery, and in addition the air can be introduced into the oxygen flow field plate 18 from the communication holes 24b′.

As shown in FIG. 7, the nut 40 for clamping the unit cells 10 together has a hollow hole formed through a central portion thereof, and an internally-threaded portion is formed on an inner surface of this hollow hole, and extends axially to a central portion of this inner surface from that side of the nut 40 facing the end plate 24a, and the tie bolt 26 can be threaded into this internally-threaded hole. At least two fuel flow passages are provided radially outwardly of the internally-threaded portion, and communicate with the hollow hole, and serve as fuel supply ports for supplying fuel to the fuel distribution manifold 32. A circular groove, in which an O-ring is fitted, is formed in that side of the nut 40 facing the end plate 24a.

As shown in FIG. 7, an internally-threaded portion 56 is formed in the other nut 50, and extends axially to a central portion thereof as in the nut 40, so that the threaded end portion of the tie bolt 26 can be threaded into this internally-threaded portion 56, and communication holes for communicating with the fuel distribution manifold 32 are formed radially outwardly of this internally-threaded portion 56. A bleeder valve of stainless steel, which enables the charging of fuel with a one-touch operation, is mounted on that side of the nut 50 facing away from the internally-threaded portion 56 in the axial direction, and fuel can be charged and discharged relative to the fuel distribution manifold 32 and the fuel electrode 13a through the communication holes so as to assist in charging the fuel. A circular groove is formed in that side of the nut 50 facing the end plate 24b, and an O-ring is fitted in this circular groove.

The fuel distribution manifold 32 is provided for supplying fuel and for absorbing and holding produced water, and this fuel distribution manifold 32 is formed by retaining hydrophilic synthetic fiber yarns on flanges, formed respectively at opposite ends of a tubular housing, in such a manner that these synthetic fiber yarns are arranged around the tubular housing, and extend between the two flanges along an axis thereof.

The air-breathing fuel cell of the above construction can be assembled in the following manner.

First, a nut 40 is beforehand attached to one end portion of a tie bolt 26, and preferably in a vertically-erected condition of the tie bolt 26, a fuel distribution manifold 32 is fitted on the tie bolt 26. The tie bolt 26, thus having the fuel distribution manifold 32 fitted thereon, forms a center shaft of the fuel cell.

Outermost end plate 24 and end gasket 28 are fitted at their center holes on this center shaft in this order, and then in order to form a unit cell 10, a separator plate 34, a fuel electrode 13a, an outer seal 16 (fitted on the outer periphery of this fuel electrode 13a), a solid polymer electrolyte membrane 12, an inner seal 22, and oxygen electrode 13b and oxygen flow field plate 18 (fitted on the outer periphery of this inner seal 22), and a separate plate 34 are sequentially fitted at their central holes on the center shaft, and are stacked together, thereby assembling the unit cell. Thereafter, in order to form the next unit cell 10, with respect to the rear separator plate 34 of the preceding unit cell 10, a fuel electrode 13a, an outer seal 16 (fitted on the outer periphery of this fuel electrode 13a), a solid polymer electrolyte membrane 12, an inner seal 22, and oxygen electrode 13b and oxygen flow field plate 18 (fitted on the outer periphery of this inner seal 22), and a separate plate 34 are sequentially fitted at their central holes on the center shaft, and are assembled together as described above for the preceding unit cell 10. This unit cell-assembling operation is repeated so that a required number of unit cells 10, corresponding to a required output of the air-breathing fuel cell, can be stacked and assembled together.

Finally, an end plate 24 is fitted at its center hole on the center shaft, and is stacked on the separator plate 34 of the outermost unit cell 10, with an end gasket 28 held therebetween. This stack of unit cells 10 are held together at a predetermined pressure, for example, of about 1.5 MPa. In this condition, the other nut 50, having a bleeder valve 52 attached thereto, is threaded on the threaded end portion of the tie bolt 26 forming the center shaft, and the stack is tightened with a predetermined torque, for example, of 6.8 Nm, and is fastened.

In order that the thus assembled fuel cell can serve as an air-breathing fuel cell, a tube or the like is connected to the nut 40 so as to supply fuel thereto from a hydrogen-generating apparatus or the like. Fuel such as hydrogen is supplied to the fuel distribution manifold 32 via the hollow hole 42 (serving as the fuel supply hole) and the fuel flow passages 44 in the nut 40, and is fed to the inner peripheral edge of the fuel electrode 13a of each of the unit cells 10 via the fuel distribution manifold 32 extending along the tie bolt 26. The fuel electrode 13a is formed of a sheet-like carbon material member, and therefore the fuel can be fed radially outwardly from the inner peripheral edge of the fuel electrode 13a through pores in this porous material without the need for providing any fuel flow field plate, and since the outer periphery of the fuel electrode 13a is sealed by the outer seal 16, the fuel can be fed to be supplied to the solid polymer electrolyte membrane 12. The oxygen electrode 13b and the oxygen flow field plate 18 are provided on the opposite side of this solid polymer electrolyte membrane 12, and therefore the outside air is fed through pores in the oxygen flow field plate 18 made of a porous material, and oxygen in the air is supplied to the oxygen electrode 13b.

The fuel and oxygen, thus fed respectively to the both sides of the solid polymer electrolyte membrane 12, chemically react with each other at this membrane 12, and the fuel electrode serves as a cathode while the oxygen electrode serves as an anode, so that an electric power-generating operation is effected. At this time, although water and heat are produced because of hydration, the produced water is absorbed by the hydrophilic synthetic fiber yarns of the fuel distribution manifold 32, and therefore the produced water will not reside in the fuel distribution manifold 32, and hence will not prevent the supply of fuel to the fuel electrode 13a. And besides, the water is evaporated by produced heat, and is dissipated into the atmosphere. The separator plates 34 are larger in radius than the other components, and therefore that portion of each separator plate 34, projecting radially outwardly beyond the other components, functions as a radiating fin for radiating the produced heat.

The dimensions of the fuel cell components of the above embodiments are not limited to the illustrated values, but have been given merely by way of example, and can be determined in accordance with the required output depending on a selected application.

The air-breathing fuel cells of the present invention, having the above construction, achieve the following advantageous effects.

In the above air-breathing fuel cell, the end plate, the end gasket and the current collector plate have the communication passage which is open outwardly, and communicates with the flow field plate of the cell portion, and therefore the outside air can be fed to the oxygen flow field plate via the shortest path, that is, via the end plate, end gasket and current collector plate, so as to supply oxygen (the air) to the oxygen electrode, and a sufficient amount of oxygen can be supplied while minimizing a flow resistance, thus achieving an excellent advantage that the power generating performance is enhanced.

The cell portion comprises the pair of symmetrical unit cells, and the end plate and end gasket (provided at each of the opposite ends of the cell portion) and each current collector plate of each unit cell have the communication passage in communication with the corresponding flow field plate. Therefore, for supplying the air to the two unit cells, the outside air can be supplied to the oxygen flow field plate of each unit cell via the communication passage in the end plate and further via the through holes in the end gasket and current collector plate, and there is achieved an excellent advantage that not only the power generating performance of each unit cell can be enhanced, but also the power generating capacity can be enhanced because of the provision of the two unit cells having generally the same power generating performance.

The communication passage, formed in the end plate, the end gasket and the current collector plate, is defined by the plurality of through holes whose axes are parallel to the axis of the cell portion, and therefore the air outside can be introduced into that side of the oxygen flow field plate, facing away from the oxygen electrode, generally uniformly over an entire area thereof, and therefore oxygen can be supplied to the oxygen flow field plate uniformly over the entire area thereof, thereby achieving an advantage that the power generating performance can be enhanced by supplying a sufficient amount of oxygen.

The communication passage, formed in the end plate, is defined by the grooves which are formed in that side of the end plate, facing the cell portion, and are open outwardly perpendicularly to the axis of the cell portion. Therefore, even in the type of fuel cell in which a plurality of unit cells are stacked together, that is, the oxygen flow field plate is provided at a central position remote from the outside of the cell portion, a sufficient amount of the air can be supplied to the oxygen flow field plate of each unit cell via the grooves when the end plate of this type, together with the end gasket, is held between the adjacent unit cells, and therefore there is achieved an advantage that even in the type of fuel cell comprising the plurality of unit cells, the overall cell performance can be enhanced.

What is claimed is:

1. An air-breathing fuel cell stack comprising a pair of end plates; a plurality of cell portions, which are provided between said two end plates in such a manner that each cell portion is interposed between end gaskets; a fuel distribution manifold provided in central portions of said cell portions so as to supply fuel thereto; a single tie bolt passing through a central portion of said fuel distribution manifold and the central portions of said cell portions so as to clamp said fuel cell components together into a unitary construction; and a pair of fixing bolts threaded respectively on both end portions of said tie bolt through respective O-rings to clamp said plurality of cell portions together between said two end plates;
wherein said cell portion includes a polymer electrolyte membrane, an oxygen electrode and a fuel electrode disposed respectively on both sides of said polymer electrolyte membrane in opposed relation to each other, a flow field plate disposed adjacent to said oxygen electrode, and a pair of current collector plates disposed respectively adjacent to an outer side of said flow field plate and an outer side of said fuel electrode; and
wherein said end plate, said end gasket and said current collector plate have communication passages which is open outwardly, and communicates with said flow field plate of said cell portion.

2. An air-breathing fuel cell stack according to claim 1, wherein said communication passage, formed in said end plate, said end gasket and said current collector plate, is defined by a plurality of through holes whose axes are substantially parallel to an axis of said cell portion.

3. An air-breathing fuel cell according to claim 2, wherein said cell portion comprises a pair of symmetrical unit cells, and each of said end plates, provided respectively at the both ends of said cell portion, has the communication passage in communication with said flow field plate of the corresponding unit cell of said cell portion.

4. An air-breathing fuel cell according to claim 1, wherein said communication passages, formed in said end plate, is defined by grooves which are formed in that side of said end plate, facing said cell portion, and are open outwardly substantially perpendicularly to an axis of said cell portion.
